(19) United States
(12) Patent Application Publication
(10) Pub. No.: US 2022/0101186 A1
(43) Pub. Date: Mar. 31, 2022

(54) MACHINE-LEARNING MODEL RETRAINING DETECTION

(71) Applicant: International Business Machines Corporation, Armonk, NY (US)

(72) Inventors: Ruhi Sharma Mittal, Bangalore (IN); Lokesh Nagalapatti, Chennai (IN); Nitin Gupta, Saharanpur (IN); Hima Patel, Bangalore (IN)

(21) Appl. No.: 17/036,843

(22) Filed: Sep. 29, 2020

(51) Int. Cl. G06N 20/00; G06K 9/62

(52) U.S. Cl. CPC G06N 20/00; G06K 9/6202; G06K 9/6262; G06K 9/6256; G06K 9/623

(57) ABSTRACT

One embodiment provides a method, including: obtaining predictions generated by a deployed machine-learning model; generating, from the obtained predictions, a validation dataset comprising a plurality of data points, wherein the validation dataset is generated in view of user preferences related to desired performance metrics of the deployed machine-learning model; ranking the plurality of data points of the validation dataset in view of the user preferences; determining the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and retraining the deployed machine-learning model utilizing a new training dataset being based upon the validation dataset and the ranked plurality of data points.

### BACKGROUND

Machine learning is the ability of a computer to learn without being explicitly programmed to perform some function. Thus, machine learning allows a programmer to initially program an algorithm that can be used to predict responses to data, without having to explicitly program every response to every possible scenario that the computer may encounter. In other words, machine learning uses algorithms that the computer uses to learn from and make predictions regarding to data. Machine learning provides a mechanism that allows a programmer to program a computer for computing tasks where design and implementation of a specific algorithm that performs well is difficult or impossible. To implement machine learning, the computer is initially taught using machine learning models that are trained using sample inputs or training datasets. The computer can then learn from the machine learning model to make decisions when actual data are introduced to the computer.

### BRIEF SUMMARY

In summary, one aspect of the invention provides a method, comprising: obtaining predictions generated by a deployed machine-learning model; generating, from the obtained predictions, a validation dataset comprising a plurality of data points, wherein the validation dataset is generated in view of user preferences related to desired performance metrics of the deployed machine-learning model; ranking the plurality of data points of the validation dataset in view of the user preferences; determining the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and retraining the deployed machine-learning model utilizing a new training dataset being based upon the validation dataset and the ranked plurality of data points.

Another aspect of the invention provides an apparatus, comprising: at least one processor; and a computer readable storage medium having computer readable program code embodied therewith and executable by the at least one processor; wherein the computer readable program code is configured to obtain predictions generated by a deployed machine-learning model; wherein the computer readable program code is configured to generate, from the obtained predictions, a validation dataset comprising a plurality of data points, wherein the validation dataset is generated in view of user preferences related to desired performance metrics of the deployed machine-learning model; wherein the computer readable program code is configured to rank the plurality of data points of the validation dataset in view of the user preferences; wherein the computer readable program code is configured to determine the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and wherein the computer readable program code is configured to retrain the deployed machine-learning model utilizing a new training dataset being based upon the validation dataset and the ranked plurality of data points.

An additional aspect of the invention provides a computer program product, comprising: a computer readable storage medium having computer readable program code embodied therewith, the computer readable program code executable by a processor; wherein the computer readable program code is configured to obtain predictions generated by a deployed machine-learning model; wherein the computer readable program code is configured to generate, from the obtained predictions, a validation dataset comprising a plurality of data points, wherein the validation dataset is generated in view of user preferences related to desired performance metrics of the deployed machine-learning model; wherein the computer readable program code is configured to rank the plurality of data points of the validation dataset in view of the user preferences; wherein the computer readable program code is configured to determine the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and wherein the computer readable program code is configured to retrain the deployed machine-learning model utilizing a new training dataset being based upon the validation dataset and the ranked plurality of data points.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of automatically determining if a deployed machine-learning model needs to be retrained based upon detection of an increase in performance of machine-learning model while the model is deployed.

FIG. 2 illustrates an example overall system architecture for automatically determining if a deployed machine-learning model needs to be retrained based upon detection of an increase in performance of machine-learning model while the model is deployed.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

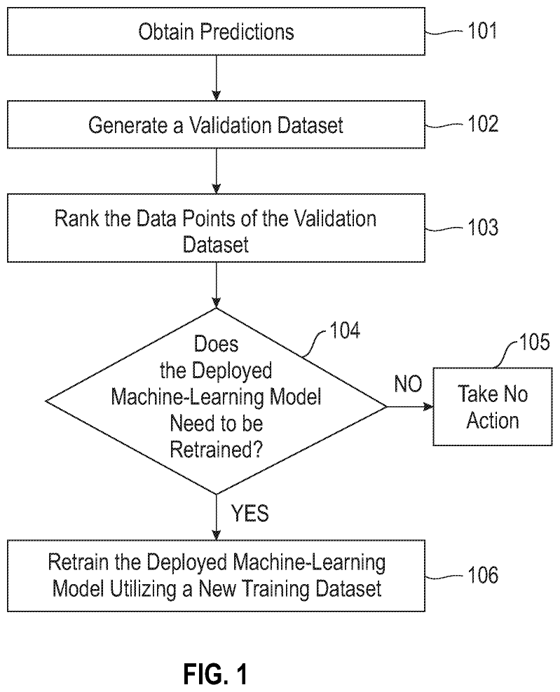

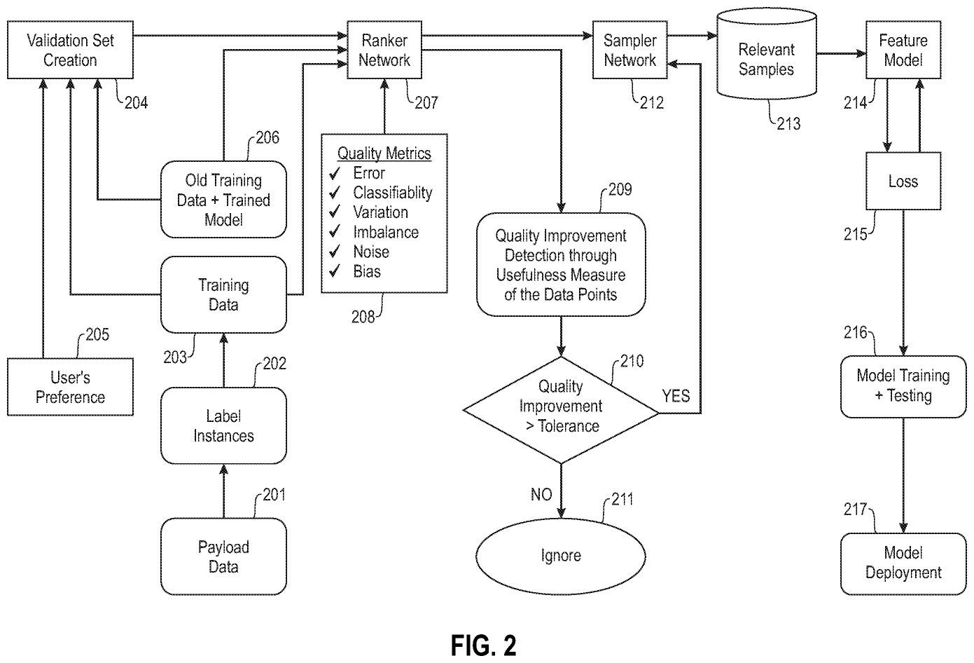

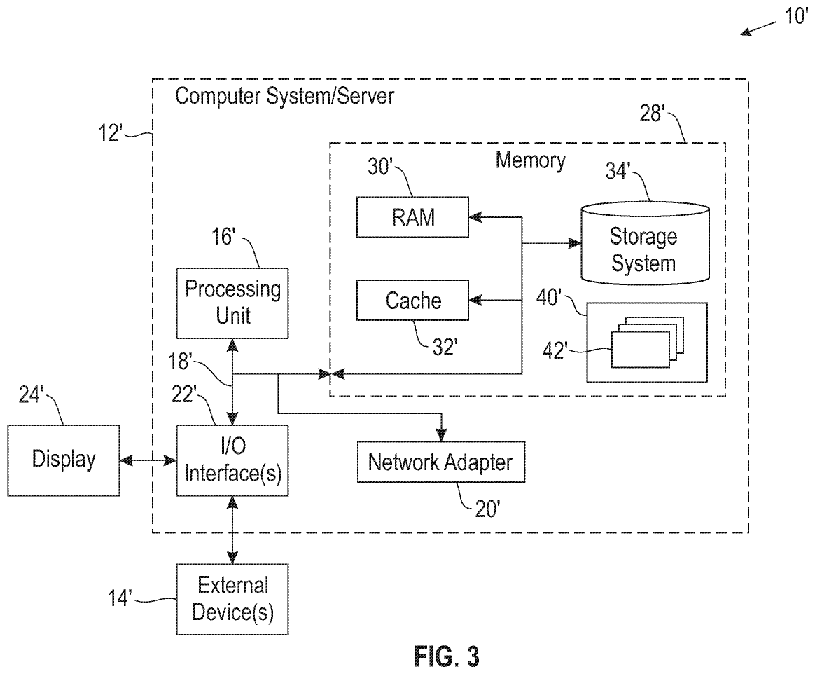

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, most if not all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Building and training machine-learning models is a very time-consuming task. One problem with machine-learning models is that the ability of the model to make predictions that reflect changes in time. In other words, a machine-learning model is trained using a training dataset that is created from data points at a particular point in time. Thus, the machine-learning model makes accurate predictions in view of the training dataset once deployed. However, over time data changes and, because the machine-learning model was trained on data from a particular point in time, the predictions made by the machine-learning model are no longer relevant to the new time period. This phenomenon is referred to as concept-drift, data-drift, or the like.

One mechanism to address this drift is to allow the machine-learning model to be retrained during deployment and based upon input that is received into the machine-learning model for example in the form of user queries or inputs into the machine-learning model. However, this can lead to people attacking the machine-learning model and purposely causing the machine-learning model to make inaccurate predictions. Additionally, these types of models are not useful or appropriate in all model applications. Therefore, users have identified techniques to compensate for the drift. Generally, the conventional techniques require that the machine-learning model is monitored and if a user detects that it is behaving differently than expected, the model is pulled from deployment, retrained using some new form of training data, and redeployed. However, such techniques require a large amount of user interaction in determining when the model should be retrained and what data should be used to retrain the model. Additionally, these techniques do not take into account different parameters regarding the model that may be desired by a user. For example, the user may want a model that has a reduced bias as compared to a different model. The conventional techniques have no mechanism that can take such preferences into account when selecting the training data to retrain the model.

Accordingly, an embodiment provides a system and method for automatically determining if a deployed machine-learning model needs to be retrained based upon detection of an increase in performance of machine-learning model while the model is deployed. Additionally, an embodiment provides a system and method for automatically selecting the data that should be used to retrain the machine-learning model and the data selection can be performed in view of user preferences. The system obtains predictions that are generated by a deployed machine-learning model. From the predictions the system generates a validation dataset that includes a plurality of data points. This validation dataset is generated in view of any user preferences related to desired performance metrics of the machine-learning model. The validation dataset may also be generated from the original training dataset that was used to initially train the machine-learning model. Thus, the data points within the validation dataset may include data points from predictions of the model and data points from the original training dataset.

The system then ranks the data points within the validation dataset in view of the user preferences, which results in a ranked list of data points where the highest ranking data points will result in a machine-learning model having the desired performance metrics. From the ranked data points, the system is able to determine whether the model needs to be retrained by comparing the ranked data points to the initial training dataset. If, based upon the comparison, a quality of the model can be increased above a predetermined threshold, the system then determines that the model should be retrained. In retraining the model, the system automatically generates a new training dataset to retrain the machine-learning model. The new training dataset is generated from the validation dataset and is based upon the ranked list of the data points. The training dataset may also include data points from the initial training dataset.

Such a system provides a technical improvement over current systems for retraining machine-learning models. Instead of relying on significant amounts of human intervention, the described system and method is able to perform the steps of determining whether the model needs to be retrained and the what data should be used to retrain the model without human intervention. Additionally, the system is able to determine whether the model needs to be retrained and what data should be used to retrain the model in view of user preferences with respect to the quality and/or performance of the machine-learning model. For example, if the user would prefer that the training of the model be based upon bias reduction, the system is able to select the training data in view of this preference. Thus, the described system and method provides a technique that allows for retraining a deployed model that is more effective and efficient at determining when the model should be retrained as compared to time-based retraining techniques. Additionally, the described system and method is able to select the data utilized to retrain the model automatically as opposed to the manual conventional techniques. Additionally, since the model automatically chooses the training dataset, the system is able to take into account user preferences regarding the performance of the model that is not possible with conventional techniques.

FIG. 1 illustrates a method for automatically determining if a deployed machine-learning model needs to be retrained based upon detection of an increase in performance of machine-learning model while the model is deployed. At 101, the system obtains predictions that are being generated by a deployed machine-learning model. The predictions are the data points that the machine-learning model is outputting in response to receiving input for labelling. In other words, the predictions correspond to data points generated by the machine-learning model. The predictions may also include labels or annotations that were generated by the machine-learning model for each of the data points or predictions. The set of predictions are also referred to as payload data.

Obtaining the dataset may include a user or system uploading the predictions to a data storage location of the system, providing a link or pointer to the predictions to the system, or the like. Additionally, or alternatively, obtaining the predictions may include the system accessing a data storage location that stores the predictions, accessing a machine-learning model building tool that includes the predictions, or the like. In other words, obtaining the predictions can be performed in any suitable manner so that the system has access to the predictions. Additionally, different portions of the predictions may be obtained in different manners. For example, one portion of the predictions may be uploaded to the system, while another portion of the predictions is stored in a data storage location accessed by the system.

At 102, the system generates a validation dataset from the predictions obtained at 101. In order to reduce the amount of information the system has to process, the system may only receive a subset of the predictions for generating the validation dataset. The number of labelled instances included in the subset may be significantly smaller than the total number of predictions. For example, the number of labelled instances utilized for generating the validation dataset may be a small percentage (e.g., 1%, 10%, 5%, etc.) of the overall number of predictions. The data points that are selected for use in generating the validation dataset may be a random selection, based upon a rule (e.g., every third point, all the data points generated at a particular time, etc.), or the like.

The validation dataset is generated automatically without user interface. In other words, a user does not have to select the data points to be used in the validation dataset. However, a user can influence the data points that are automatically selected by providing user preferences that are related to desired performance or quality metrics of the deployed machine-learning model. In other words, while the user does not have to manually select what data points to be used in the validation dataset, the user can provide an indication of desired quality or performance metrics and the system will take this into account when selecting the data points to be used in the validation dataset. Example quality or performance metrics include accuracy, bias, error, variation, classifiability, noise, imbalance, or any other metrics. The user may select one or more of these metrics for the system to take into account when selecting the data points for the validation dataset. This is a significant improvement to conventional systems that randomly select data points.

The validation dataset may also include data points that were included in the original training dataset that was used to train the deployed machine-learning model. In other words, not only does the system receive the predictions or subset of predictions for use in the validation dataset, but the system also receives or has access to the original training dataset. The system can then pull data points from either or both of the predictions dataset and the original training dataset. The user can also provide weights to the two data point sets. For example, the user may weight the original training dataset higher so that the validation dataset may be more likely to pull data points from the original training dataset than the predictions dataset. This may be desired so that the validation dataset does not overfit only on the predictions dataset. Alternatively, the user may provide a higher weight to the predictions dataset so that the validation dataset may be more likely to pull data points from the predictions dataset than the original training dataset.

To generate the validation dataset the system pulls data points from one or both of the dataset sets (i.e., the predictions dataset and the original training dataset) and creates a group of data points, referred to as a validation dataset. When selecting the data points the system takes into account the user preferences and any weights that the user has provided. Thus, the validation dataset includes data points that would assist in building a machine-learning model having the desired quality or performance metrics. Additionally, one of the important features of a machine-learning model is the accuracy of the machine-learning model. Thus, regardless of whether the user has provided an indication of a desired accuracy, the system selects data points for the validation dataset that would assist in achieving a desired accuracy for the deployed model, maintaining the accuracy of the deployed model, or in view of a threshold accuracy of the deployed model, in addition to any other user preferences the user has provided.

The system then ranks the plurality of data point of the validation dataset at 103. When ranking the data points the system takes into account the user preferences and any other quality or performance metrics. In other words, data points that fulfill or support one or more of the user preferences will be ranked higher than data points that are less supportive of the user preferences or other quality or performance metrics. As an example, a data point that supports a user preference of reduction in bias and also supports the threshold accuracy would be ranked higher than a data point that only supports a single user preference. In addition to ranking the validation dataset, the system ranks the initial training dataset. The ranking of the initial training dataset is performed in a similar manner to the ranking of the validation dataset. Thus, the result of the ranking is two ranked lists, one ranked list of the data points in the validation dataset and one ranked list of the initial training dataset.

Using the ranked lists, the system determines if the deployed machine-learning model needs to be retrained at 104. To make such a determination, the system compares the ranked validation dataset to the initial training dataset, for example, the ranked list of the initial training dataset. Based upon the comparison, the system determines if a quality of the deployed machine-learning model can be increased above a predetermined threshold if the model were to be retrained based upon the validation dataset. For example, the system may utilize a similarity algorithm to determine how similar the two datasets (i.e., the ranked validation dataset and the training dataset) are to each other. The two datasets having a similarity within a predetermined similarity amount would indicate that the quality of the model would not be increased, whereas the two datasets being dissimilar would indicate that the quality of the model would be increased. The amount of similarity between the datasets provides an indication regarding data-drift.

If the system determines that the quality of the deployed machine learning model would not be increased above a predetermined threshold at 104, the system may take no action at 105. This determination may occur if the similarity of the datasets is within a particular similarity measure. In other words, if the validation dataset has the same data distribution as the old training dataset, the datasets may be identified as similar and there would be little to no increase in the quality of the model by retraining the model. Having a similar data distribution may indicate that there has been no concept-drift or data-drift in data since the model has been last trained.

The system may also take no action if the system determines that there is a difference in data distribution but there is no improvement in the quality of the model if it were retrained. Another technique for determining if there may be a quality improvement in the model is to provide a random sample of the validation dataset to the model and determine if the model makes accurate predictions on the validation dataset. If the model performs well on the sample of the validation dataset, then this indicates that there is no concept-drift and there would not be an increase in the quality of the model if retrained based upon the validation dataset.

On the other hand, if the system determines that a quality of the model could be increased through retraining, the system may retrain the deployed model at 106. The system may determine that the quality of the model can be increased if the system determines that the data distribution is dissimilar (e.g., the datasets are dissimilar above a predetermined threshold), which indicates data-drift, and the model performs poorly with respect a random sample of the validation dataset, which indicates concept-drift. Additionally, the system may determine that the model should be retrained based upon just a single factor. For example, a user may be concerned about one of data-drift or concept-drift. Thus, the user may indicate the model should be retrained if only a single one of these is identified. Up to this point, the model can remain deployed. In other words, steps 101-105 can be performed while the model remains deployed. Only if the system determines that the model needs to be retrained does the model need to be taken out of service so that it can be retrained.

The system automatically selects the data points that should be used to retrain the machine-learning model, as opposed to conventional techniques where a user must select the data points to be used in the new training dataset. Thus, the system automatically creates a new training dataset to retrain the model. The new training dataset is based upon the validation dataset and the ranked data points. In other words, the new training dataset is not necessarily the exact same as the validation dataset. Rather, the new training dataset may include some of the data points included in the validation dataset. Additionally, the new training dataset may include data points from the original training dataset. When selecting what data points to utilize, the system utilizes the data points that provide the highest impact to the quality or performance of the model while requiring the fewest data points. Thus, the system may refer to the ranking in order to select the data points which may have the most impact on the quality or performance of the model.

Additionally, in order to determine what points should be included in the new training dataset, the system may create an initial new training dataset. The system may then add, remove, and swap data points within the new training dataset and analyze the effect of the modification (e.g., addition, removal, replacement, etc.) on the usefulness of the training dataset, for example, by calculating or analyzing a loss function. Modifications having a minimal or negative change may be reversed, whereas modifications having a positive change may be maintained. This process occurs iteratively until the effect of modifications is no longer positive or has very little effect. Once this point is achieved, the new training dataset is finalized and includes a minimum number of data points having the biggest impact on the quality or performance of the model.

The new training dataset is used to retrain the machine-learning model. At this point, the model has to be taken out of service so that it can be retrained. Once the model is retrained, the model can be tested. The model may be tested to ensure that it is still performing as expected. Additionally, the model may be tested to ensure that the desired quality metrics are achieved. After the model has been tested it can be redeployed. The redeployed model is now corrected for any concept-drift or data-drift. Additionally, in retraining the model, the system automatically determined that it should be retrained and automatically selects what data to use in retraining the model, which minimizes the amount of user intervention required in retraining the model.

FIG. 2 illustrates an example overall system architecture for the described system and method. The system obtains the payload data 201 from the deployed machine-learning model. The system labels instances 202 of the payload data 201. The number of instances that are labelled are a small subset of the payload data 201. These labelled instances 202 are made part of a possible new training dataset 203. The data points in the possible new training dataset 203 are provided to the validation set creation module 204. Additionally, the validation set creation module 204 is provided with user preferences 205. The user preferences 205 are related to desired performance metrics of the machine-learning model, for example, bias, classifiability, error rate, variation, imbalance, noise, or the like. In other words, the user preferences 205 allow the user to identify which performance metrics of the machine-learning model should be given higher priority in training or retraining the model.

The validation set creation module 204 may also receive as input the initial or old training data that was used to train the deployed model 206. The validation set creation module 204 creates a validation dataset that includes a plurality of data points that are selected from the possible new training dataset 203 and/or the old training dataset 206. The data points included in the validation dataset are chosen in view of the user preferences 205. In other words, the validation set creation module 204 puts a higher weight on data points that would increase the desired quality or performance metric(s) identified within the user preferences 205.

The validation dataset, old training dataset 206, and possible new training dataset 203, are then provided to a ranker network module 207. The ranker network module ranks the data points included in the validation dataset based upon some quality metrics 208 related to the machine-learning model. These quality metrics 208 may be the same metrics that were identified in the user preferences 205. Once the validation dataset data points are ranked, the ranker network module 207 compares the ranked data points to the old training dataset 206. Based upon the comparison the system can determine, at 209, what improvement in the quality of the machine-learning model would be obtained if the validation dataset or possible new training dataset 203 were used to retrain the model as compared to the old training dataset 206. If the improvement in quality is not greater than a predetermined threshold as determined at 210, then the system may ignore the validation dataset and possible new training dataset 203. In other words, if an improvement in the quality of the model would not reach a predetermined threshold then the system will choose not to retrain the model.

On the other hand, if the improvement in quality is greater than a predetermined threshold at 210, then the system provides the ranked data points generated by the ranker network module 207 to a sampler network module 212. The sampler network module 212 selects data points to be used in retraining the machine-learning model. The sampler network module 212 attempts to select the minimal number of data points that would result in the greatest increase in the quality. The sampler network module 212 can select data points from the possible new training dataset 203, the old training dataset 206 to be included as a relevant sample 213. To select the minimum number of optimal samples (i.e., the samples having the maximum impact on the desired quality metric), the system generates a feature model 214 from the samples. The system then performs an iterative analysis of adding, removing, and swapping samples included in the feature model 214 and determining the loss 215 from the modifications. The loss 215 provides an indication of how useful a sample point is within the feature model 214. Once the feature model 214 is optimized, the system uses it to retrain the model and performs testing on the retrained model 216. If the testing performs well, the retrained model is deployed 217.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
obtaining predictions generated by a deployed machine-learning model;
generating, from the obtained predictions, a validation dataset comprising a plurality of data points, wherein the validation dataset is generated in view of user preferences related to desired performance metrics of the deployed machine-learning model;
ranking the plurality of data points of the validation dataset in view of the user preferences;
determining the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and
retraining the deployed machine-learning model utilizing a new training dataset being based upon the validation dataset and the ranked plurality of data points.

2. The method of claim 1, further comprising labelling a subset of the predictions and wherein the validation dataset is generated from the labelled subset.

3. The method of claim 1, wherein the validation dataset is further generated from the training dataset used to train the deployed machine-learning model.

4. The method of claim 1, wherein the ranking comprises ranking data points of the training dataset in addition to the data points of the validation dataset.

5. The method of claim 1, wherein the wherein the validation dataset is generated in view of maintaining a threshold accuracy of the deployed machine-learning model in addition to the user preferences.

6. The method of claim 1, wherein the new training dataset comprises data points from the training dataset used to train the deployed machine-learning model.

7. The method of claim 1, wherein the new training dataset comprises a minimum number of data points to meet the desired performance metrics.

8. The method of claim 1, wherein the deployed machine-learning model is not retrained when the quality of the deployed machine-learning model will not be increased above the predetermined threshold.

9. The method of claim 1, further comprising testing and redeploying the retrained deployed machine-learning model.

10. The method of claim 1, wherein the generating, ranking, and determining occurs while the deployed machine-learning model remains deployed.

11. An apparatus, comprising:
at least one processor; and
a computer readable storage medium having computer readable program code embodied therewith and executable by the at least one processor;
wherein the computer readable program code is configured to obtain predictions generated by a deployed machine-learning model;
wherein the computer readable program code is configured to generate, from the obtained predictions, a validation dataset comprising a plurality of data points, wherein the validation dataset is generated in view of user preferences related to desired performance metrics of the deployed machine-learning model;
wherein the computer readable program code is configured to rank the plurality of data points of the validation dataset in view of the user preferences;
wherein the computer readable program code is configured to determine the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and
wherein the computer readable program code is configured to retrain the deployed machine-learning model utilizing a new training dataset being based upon the validation dataset and the ranked plurality of data points.

12. A computer program product, comprising:
a computer readable storage medium having computer readable program code embodied therewith, the computer readable program code executable by a processor;
wherein the computer readable program code is configured to obtain predictions generated by a deployed machine-learning model;
wherein the computer readable program code is configured to generate, from the obtained predictions, a validation dataset comprising a plurality of data points, wherein the validation dataset is generated in view of user preferences related to desired performance metrics of the deployed machine-learning model;
wherein the computer readable program code is configured to rank the plurality of data points of the validation dataset in view of the user preferences;
wherein the computer readable program code is configured to determine the deployed machine-learning model needs to be retrained by comparing the ranked plurality of data points to a training dataset used to train the deployed machine-learning model and identifying, based upon the comparison, a quality of the deployed machine-learning model can be increased above a predetermined threshold; and
wherein the computer readable program code is configured to retrain the deployed machine-learning model utilizing a new training dataset being based upon the validation dataset and the ranked plurality of data points.

13. The computer program product of claim 12, further comprising labelling a subset of the predictions and wherein the validation dataset is generated from the labelled sub set.

14. The computer program product of claim 12, wherein the validation dataset is further generated from the training dataset used to train the deployed machine-learning model.

15. The computer program product of claim 12, wherein the ranking comprises ranking data points of the training dataset in addition to the data points of the validation dataset.

16. The computer program product of claim 12, wherein the wherein the validation dataset is generated in view of maintaining a threshold accuracy of the deployed machine-learning model in addition to the user preferences.

17. The computer program product of claim 12, wherein the new training dataset comprises data points from the training dataset used to train the deployed machine-learning model.

18. The computer program product of claim 12, wherein the new training dataset comprises a minimum number of data points to meet the desired performance metrics.

19. The computer program product of claim 12, wherein the deployed machine-learning model is not retrained when the quality of the deployed machine-learning model will not be increased above the predetermined threshold.

20. The computer program product of claim 12, wherein the generating, ranking, and determining occurs while the deployed machine-learning model remains deployed.
